(19) United States
(12) Patent Application Publication
(10) Pub. No.: US 2007/0212264 A1
(43) Pub. Date: Sep. 13, 2007

(54) Multi-well sample plate cover penetration system

(75) Inventor: Neil Reginald Beer, Pleasanton, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/652,879

(22) Filed: Jan. 11, 2007

Related U.S. Application Data
(63) Continuation-in-part of application No. 11/342,361, filed on Jan. 26, 2006.

(51) Int. Cl. B01L 3/00

(52) U.S. Cl. 422/99

(57) ABSTRACT

An apparatus for penetrating a cover over a multi-well sample plate containing at least one individual sample well includes a cutting head, a cutter extending from the cutting head, and a robot. The cutting head is connected to the robot wherein the robot moves the cutting head and cutter so that the cutter penetrates the cover over the multi-well sample plate providing access to the individual sample well. When the cutting head is moved downward the foil is pierced by the cutter that splits, opens, and folds the foil inward toward the well. The well is then open for sample aspiration but has been protected from cross contamination.

### CROSS-REFERENCE TO RELATED APPLICATIONS

This application is a Continuation-in-Part of U.S. patent application Ser. No. 11/342,361 titled, “Multi-Well Sample Plate Cover Penetration System,” filed Jan. 26, 2006 by Neil Reginald Beer. U.S. patent application Ser. No. 11/342,361 titled, “Multi-Well Sample Plate Cover Penetration System,” filed Jan. 26, 2006 by Neil Reginald Beer is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to multi-well plates and more particularly to a multi-well sample plate cover penetration system.

2. State of Technology

United States Patent Application No. 2005/0047971 by James G. Clements et al for Multi-well Plate and Method of Manufacture published Mar. 3, 2005 provides the following state of technology information: “Assays of biochemical systems are carried out on a large scale in both industry and academia, so it is desirable to have an apparatus that allows these assays to be performed in convenient and inexpensive fashion. Because they are relatively easy to handle, are low in cost, and generally disposable after a single use, multiwell plates are often used for such studies. Multiwell plates typically are formed from a polymeric material and consist of an ordered array of individual wells. Each well includes sidewalls and a bottom so that an aliquot of sample may be placed within each well. The wells may be arranged in a matrix of mutually perpendicular rows and columns. Common sizes for multiwell plates include matrices having dimensions of 8×12 (96 wells), 16×24 (384 wells), and 32×48 (1536 wells).”

United States Patent Application No. 2005/0226786 by David Clarence Hager et al for Multi-well Apparatus published Oct. 13, 2005 provides the following state of technology information: “An optional cover may be provided for covering the open tops of the wells of the multi-well block.”

U.S. Pat. No. 6,939,516 for Multi-well Plate Cover and Assembly Adapted for Mechanical Manipulation issued Sep. 6, 2005 to John P. Hall et al provides the following state of technology information: “The multi-well plates, being liquid-filled and subject to storage, have a number of lidding options available to the user. The simplest form of cover is a molded plastic lid that loosely fits over the multi-well plate. For some researchers this may provide an adequate seal, but other researchers may require a more robust cover that provides for protection from both the ingress and egress of materials into the individual wells. The nature of ingression can include the absorbence of material such as water in the presence of DMSO (dimethyl sulfoxide), a preferred storage solvent with a hygroscopic nature, and transfer of materials between wells. Egression can include the loss of volume due to evaporation or sublimation. Another form of lidding is that of an adhesive seal type cover such as Costar® Thermowell® sealers (Catalog No. 6570). An adhesive seal is approximately 3″×5″ and consists of a substrate material such as a thin foil or plastic film to which an adhesive has been applied. These seals can be applied by mechanical or manual means. The adhesive seal is removed by hand as there is no mechanical device for removal. The adhesive seal provides superior sealing properties in contrast to the plastic lid but has a number of deficiencies: (1) it can only be used once; (2) its adhesive can come in contact with the stored entity; and (3) during removal if any of the stored entity is on the inner surface of the seal, it may be problematic for worker safety. Additionally, if repeated seals are applied to the same multi-well plate the adhesive tends to build up, compromising the seals of successive applications. Yet another form of lidding is the use of a heat-sealed cover such as the Abgene Easy Peel Polypropylene Sealing Film (Catalog No. AB-0745). A heat-sealed cover is 3″×5″ and consists of a substrate material such as polypropylene film. Most of the multi-well plates used for storage are polypropylene. With the application of heat and pressure by means of an Abgene Combi Thermal Sealer, the heat-sealed cover can be bonded to the polypropylene multi-well plate on the plate's upper surface. This seal is in essence a molecular bond caused by the melting of the polypropylene of the respective entities. As such, the heat seal cover sets the standard for multi-well plate sealing in terms of protection from both the ingress and egress of materials into the individual wells. It can be applied by manual and mechanical means such as the Abgene 1000, a semi-automatic applicator that uses roll stock of the Abgene Easy Peel Sealing Film. However, there is no mechanical device for the removal of heat-sealed covers. Heat-sealed covers cannot be reused. Each time a heat-sealed cover is attached to the plate there can be distortion on the standoffs of the individual wells, plus polypropylene remnants, affecting the quality of future seals on the same plate.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

Laboratory analysis of chemical and biological samples is a time consuming process involving hundreds to thousands of samples for a typical test. These labor driven processes have led to the development of laboratory automation systems, now commonplace, that aspirate, mix, dispense, heat, and perform other operations according to the specific experimental protocols on large numbers of samples simultaneously. Current standards include the 96-well (an 8 by 12 array) and the 384-well (a 16 by 24 array) plates that hold the liquid samples during processing and move between robotic platforms. To keep the liquid solutions inside the well, the plates are sealed typically with an adhesive backed aluminum foil tape as the most cost effective method. (Other sealing methods are much more expensive, time consuming, and only marginally more effective, involving multi-piece assemblies with coverlocks, diaphragms, or other mechanisms. Thus they are not widely used.)

The plates are then transferred, heated, centrifuged, bead beaten (vibrated on a shaker while beads previously deposited in the wells mix the sample and breakdown fibers, cell walls, spores, and other structures), and other operations depending on the specific experiment protocol. After these processes are performed the samples then need to be aspirated for chemical detection or subsequent tests, necessitating well penetration. Cross-contamination concerns require the wells are accessed with a minimum of aerosol generation. Standard aluminum sealing tape is used in mixing and beating processes.

Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

The present invention provides an apparatus for penetrating a cover over a multi-well sample plate containing at least one individual sample well. The apparatus includes a cutting head, a cutter extending from the cutting head, and a robot. The cutting head is connected to the robot wherein the robot moves the cutting head and cutter so that the cutter penetrates the cover over the multi-well sample plate providing access to the individual sample well. When the cutting head is moved downward the foil is pierced by the cutter that splits, opens, and folds the foil inward toward the well. The well is then open for sample aspiration but has been protected from cross contamination.

The present invention provides an array cutting and tape folding tool that can be used for 96-well, 384-well geometries, and other geometries. The system will be robotically operating and will cut, open, and fold inward the sealing tape so that samples can be subsequently aspirated without the need for human intervention to remove the seal (an aerosol generating and contaminating process).

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 is an exploded view that illustrates a system constructed in accordance with one embodiment of the present invention.

FIG. 2 illustrates a system constructed in accordance with one embodiment of the present invention.

FIG. 3 illustrates as system constructed in accordance with another embodiment of the present invention.

FIG. 4 shows the cutter in greater detail.

FIG. 5 is a bottom view of the cutter.

FIG. 6 illustrates another system constructed in accordance with one embodiment of the present invention.

FIG. 7 illustrates another system constructed in accordance with one embodiment of the present invention.

FIG. 8 illustrates yet another system constructed in accordance with one embodiment of the present invention.

FIG. 9 illustrates shows the circular cutter head in greater detail.

FIG. 10 is a bottom view of another embodiment of the cutter.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

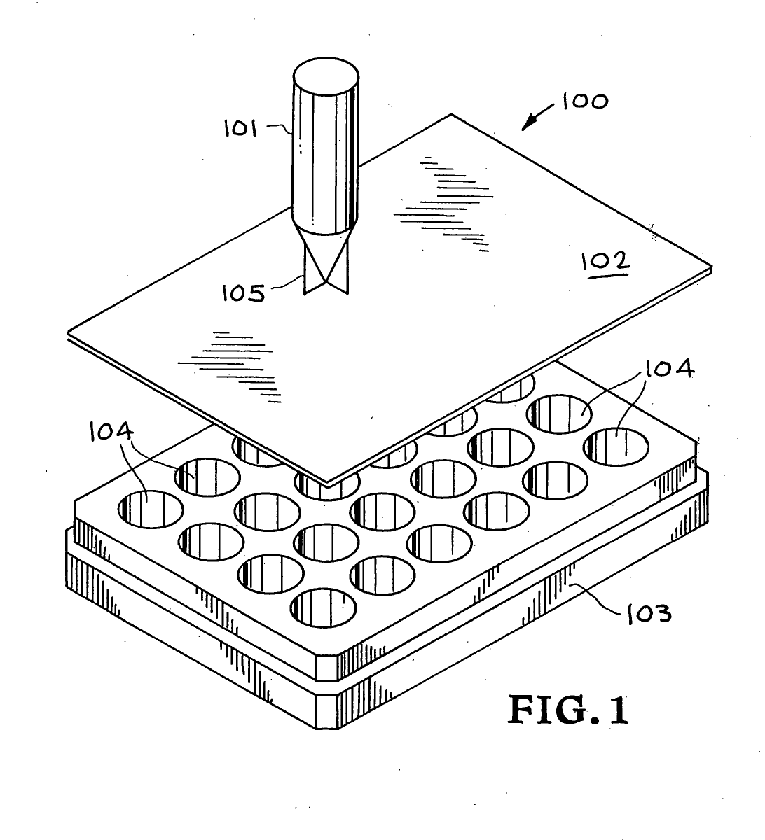

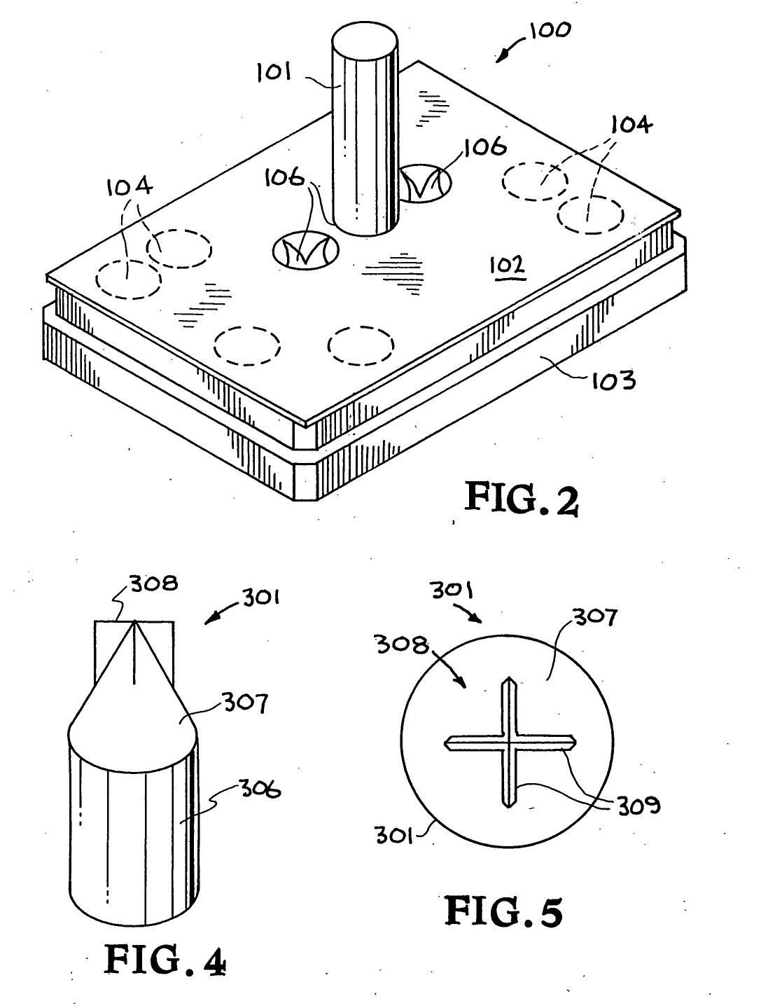

Referring now to FIGS. 1 and 2 of the drawings, one embodiment of a multi-well sample plate cover penetration system constructed in accordance with the present invention is illustrated. This embodiment of the present invention is designated generally by the reference numeral 100. The system 100 comprises an individual well cutting head 101 positioned to penetrate a cover 102 of a multi-well sample plate 103 containing individual sample wells 104. The cutting head 101 includes a cutter 105.

Sealed wells containing liquid samples for use in biological or chemical analyses need to be penetrated for sampling and analysis. The wells are covered with a seal such as an aluminum tape or foil 102. Instead of peeling the tape 102 off the wells 104 to access the samples and potentially cross-contaminating adjacent wells with generated aerosols or adhesive strings, as was the case of the prior art, the foil 102 is pierced by the cutter 105 of the cutting head 101 that splits, opens, and folds the foil 102 inward toward the individual well 104. The wells 104 are then open for sample aspiration but have been protected from cross contamination.

The present invention not only eliminates cross contamination, it also automates other step in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring now to FIG. 1, an exploded view of the multi-well sample plate cover penetration system 100 is illustrated. The cover 102 is shown positioned over the multi-well sample plate 103 containing the individual sample wells 104. The multi-well sample plate 103 is used in biological or chemical analyses. The wells 104 are covered by cover 102. In the embodiment shown, the cover 102 is an aluminum tape or foil. The well cutting head 101 is shown positioned above the cover 102. When the well cutting head 101 is moved downward the foil 102 is pierced by the cutter 105 that splits, opens, and folds the foil 102 inward toward the well 104. The well 104 is then open for sample aspiration but has been protected from cross contamination.

The plate 102 includes a peripheral skirt and an upper surface having the array of wells 104 each of which is capable of receiving an aliquot of sample to be assayed. Preferably, the plate 102 conforms to industry standards for multiwell plates; that is to say, a plate bordered by a peripheral skirt, laid out with 96 wells in an 8×12 matrix (mutually perpendicular 8 and 12 well rows). In addition, the height, length, and width preferably conform to industry standards. The present invention, however, can be implemented in any type of multiwell plate arrangement including 384 and 1536 wells, and is not limited to any specific number of wells or any specific dimensions.

The multi-well plate 102, is liquid-filled and may be subject to storage. The simplest form of cover is a molded plastic lid that loosely fits over the multi-well plate 102. For some researchers this may provide an adequate seal, but other researchers may require a more robust cover that provides for protection from both the ingress and egress of materials into the individual wells. The nature of ingression can include the absorbence of material such as water in the presence of DMSO (dimethyl sulfoxide), a preferred storage solvent with a hygroscopic nature, and transfer of materials between wells. Egression can include the loss of volume due to evaporation or sublimation. As illustrated in FIG. 1, a form of lidding is that of an adhesive seal type cover 102 such as Costar® Thermowell® sealers (Catalog No. 6570). An adhesive seal is approximately 3″×5″ and consists of a substrate material such as a thin foil or plastic film to which an adhesive has been applied. These seals can be applied by mechanical or manual means.

The system 100 provides an array cutting and tape folding tool 101 that can be used for 96-well, 384-well geometries, and other geometries. In other embodiments of the present invention that will be described subsequently, the system will be robotically operating and will cut, open, and fold inward the sealing tape so that samples can be subsequently aspirated without the need for human intervention to remove the seal (an aerosol generating and contaminating process).

The present invention not only eliminates cross contamination, it also automates other step in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring now to FIG. 2, the multi-well sample plate 103 is shown covered by the cover 102. The plate 102 includes a peripheral skirt and an upper surface having the array of wells 104 each of which is capable of receiving an aliquot of sample to be assayed. Preferably, the plate 102 conforms to industry standards for multiwell plates; that is to say, a plate bordered by a peripheral skirt, laid out with 96 wells in an 8×12 matrix (mutually perpendicular 8 and 12 well rows). In addition, the height, length, and width preferably conform to industry standards. The present invention, however, can be implemented in any type of multiwell plate arrangement including 384 and 1536 wells, and is not limited to any specific number of wells or any specific dimensions.

The multi-well plate 102, is liquid-filled and may be subject to storage. The simplest form of cover is a molded plastic lid that loosely fits over the multi-well plate 102. For some researchers this may provide an adequate seal, but other researchers may require a more robust cover that provides for protection from both the ingress and egress of materials into the individual wells. The nature of ingression can include the absorbence of material such as water in the presence of DMSO (dimethyl sulfoxide), a preferred storage solvent with a hygroscopic nature, and transfer of materials between wells. Egression can include the loss of volume due to evaporation or sublimation. As illustrated in FIG. 2, a form of lidding is that of an adhesive seal type cover 102 such as Costar® Thermowell® sealers (Catalog No. 6570). An adhesive seal is approximately 3″×5″ and consists of a substrate material such as a thin foil or plastic film to which an adhesive has been applied. These seals can be applied by mechanical or manual means.

Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

The foil 102 has been pierced by the cutter of the cutting head 101 that splits, opens, and folds the foil 102 inward toward the individual well 104 and provides an access opening 106. The wells 104 are then open for sample aspiration but have been protected from cross contamination. The cutting head 101 is moved from one well to another well and provides openings 106 for access to the wells. Rinsing of the cutting head 101 is performed if desired between cutting operations on individual wells 104.

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

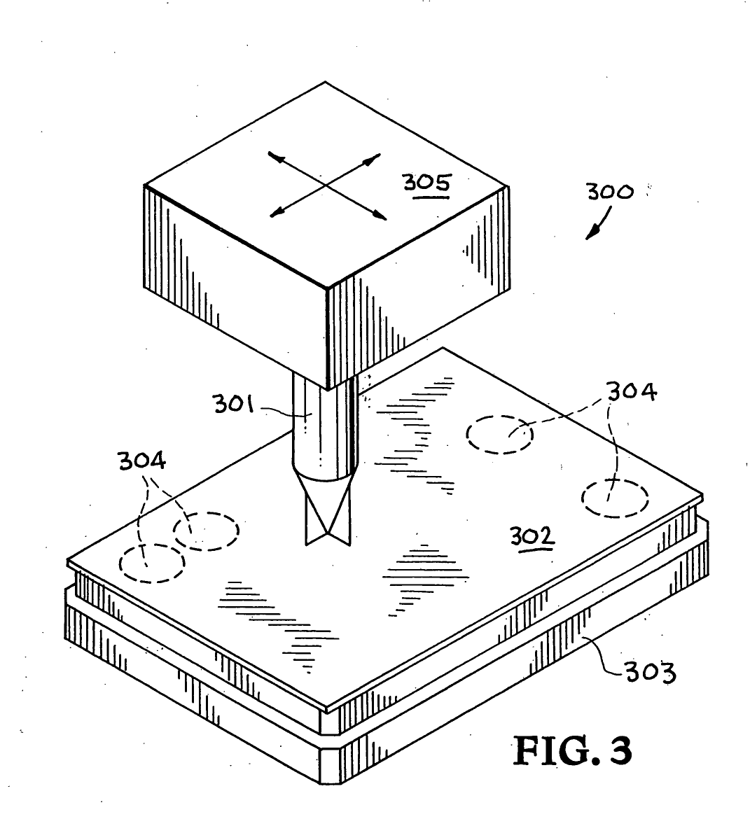

Referring now to FIG. 3, another embodiment of a multi-well sample plate cover penetration system constructed in accordance with the present invention is illustrated. This embodiment of the present invention is designated generally by the reference numeral 300. The system 300 comprises an individual well cutting head 301 positioned to penetrate a cover 302 of a multi-well sample plate 303 containing individual sample wells 304. The cutting head 301 is driven by a robot 305.

Sealed wells containing liquid samples for use in biological or chemical analyses need to be penetrated for sampling and analysis. The wells are covered with a seal such as an aluminum tape or foil 302. Instead of peeling the tape 302 off the wells 304 to access the samples and potentially cross-contaminating adjacent wells with generated aerosols or adhesive strings, as was the case of the prior art, the foil 302 is pierced by the cutter 305 of the cutting head 301 that splits, opens, and folds the foil 302 inward toward the individual well 304. The wells 304 are then open for sample aspiration but have been protected from cross contamination.

The cutter head 301 is positioned by the robot 305 above the cover 302 in the precise position for penetrating the cover 302 above an individual well 304. The robot 305 moves the cutting head 301 downward toward the foil 302. The cutter head 301 pierces the foil 302 so that the foil 302 is split open and folded inward toward the well 304. The well 304 is then open for sample aspiration but has been protected from cross contamination.

The system 300 provides an array cutting and tape folding tool 301 that can be used for 96-well, 384-well geometries, and other geometries. In other embodiments of the present invention that will be described subsequently, the system will be robotically operating and will cut, open, and fold inward the sealing tape so that samples can be subsequently aspirated without the need for human intervention to remove the seal (an aerosol generating and contaminating process).

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring now to FIG. 4, the cutting head 301 is shown in greater detail. The cutting head 301 includes a cylindrical shaft 306, a conical tip 307, and a cutting tool 308. The cutting head 301 is moved by the robot 305 shown in FIG. 3 to cause the cutting tool 308 to contact and penetrate the cover 302 over the wells of the multi-well sample plate.

The cutter tool 308 pierces the foil 302 so that the foil 302 is split open and folded inward toward the well 304. The well 304 is then open for sample aspiration but has been protected from cross contamination. The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring now to FIG. 5, a bottom view of the cutting head 301 is shown. The cutting head 301 is moved by the robot 305 shown in FIG. 3 to cause the cutting tool 308 to contact and penetrate the cover 302 over the wells of the multi-well sample plate. The cutting tool 308 portion of the cutting head 301 is in the form of an “X.” The cutting head 308 includes cross-shaped cutting blades. 309. The cross-shaped cutting blades 309 and the conical tip 307 cause the foil 302 to be folded inward toward the well.

In operation, the cutting head 301 is moved by the robot to cause the cutting tool 308 to contact and penetrate the cover over the wells of the multi-well sample plate. The cross-shaped cutting blades 309 form an “X” cut in the cover. The conical tip 307 moves into the “X” and cause the foil of the cover to be folded inward toward the well. The cutter tool 308 pierces the foil 302 so that the well is open for sample aspiration. The cross-shaped cutting blades 309 and the conical tip 307 cause the foil 302 to be folded inward toward the well. The well is open for sample aspiration but has been protected from cross contamination.

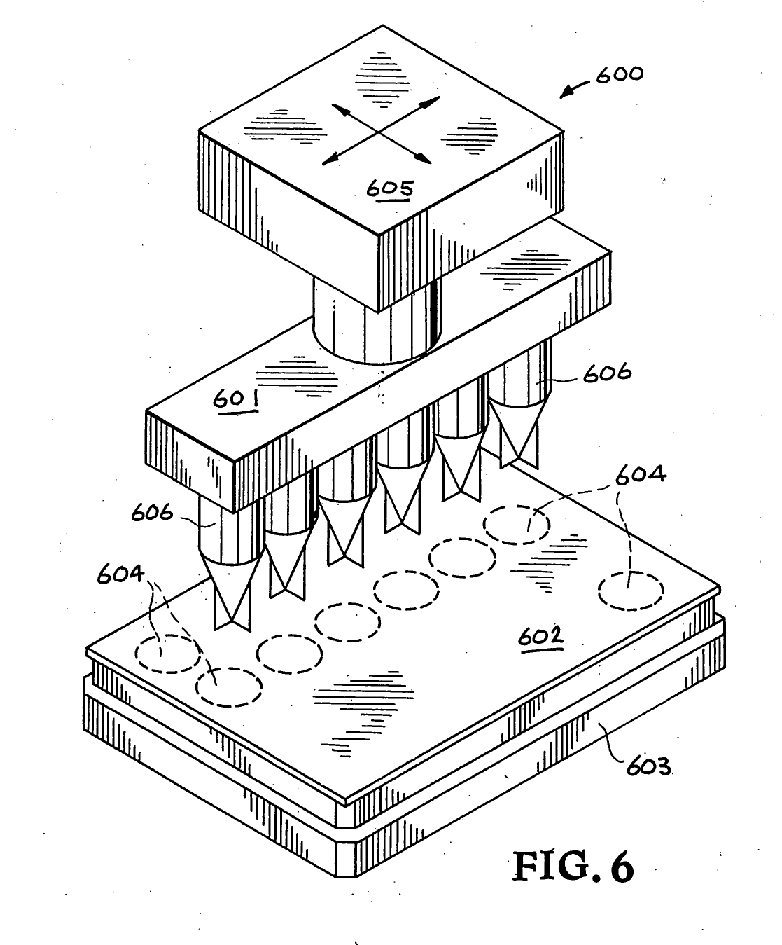

Referring now to FIG. 6, yet another embodiment of a multi-well sample plate cover penetration system constructed in accordance with the present invention is illustrated. This embodiment of the present invention is designated generally by the reference numeral 600. The system 600 comprises an array of well cutting heads 601 positioned to penetrate a cover 602 of a multi-well sample plate 603 containing a multiplicity of individual sample wells 604. The array of cutting heads 601 is driven by a robot 605. The array of cutting heads 601 includes a multiplicity of individual cutting heads 606. The individual cutting heads 606 are positioned in one or more rows along the array of well cutting heads 601. The row or rows are spaced at the same intervals as the individual sample wells 604 in the multi-well sample plate 603. This assures that an individual cutting head 606 will be immediately above a corresponding ample well 604.

The wells 606 contain liquid samples for use in biological or chemical analyses. The wells 606 are covered with a seal such as an aluminum tape or foil 602. The wells 606 need to be penetrated for sampling and analysis.

The array of cutter heads 601 is moved and positioned by the robot 605. The array of cutter heads 601 is moved so that the individual cutting heads 606 are above the cover 602 in the precise position for penetrating the cover 602 above a corresponding multiplicity of individual wells 604. The robot 605 moves the array of cutting heads 601 and the individual cutting heads 606 downward toward the foil 602. The individual cutting heads 606 pierce the foil 602. Each individual split is made so that the foil 602 is split open and folded inward toward the individual well 604. The well 604 is then open for sample aspiration but has been protected from cross contamination.

Instead of peeling the tape 602 off the wells 604 to access the samples and potentially cross-contaminating adjacent wells with generated aerosols or adhesive strings, as was the case of the prior art, the foil 602 is pierced by the cutter 605 of the cutting head 601 that splits, opens, and folds the foil 602 inward toward the individual well 604. The wells 604 are then open for sample aspiration but have been protected from cross contamination.

The system 600 provides an array of cutting and tape folding tools 606 that can be used for 96-well, 384-well geometries, and other geometries. In other embodiments of the present invention that will be described subsequently, the system will be robotically operating and will cut, open, and fold inward the sealing tape so that samples can be subsequently aspirated without the need for human intervention to remove the seal (an aerosol generating and contaminating process).

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring again to FIG. 6, the system 600 provides an array cutting and tape folding tool 401 that can be used for 96-well, 384-well geometries, and other plate geometries. In other embodiments of the present invention that will be described subsequently, the system will be robotically or manually operating and will cut, open, and fold inward the sealing tape on all the wells on the plate simultaneously so that samples can be subsequently aspirated without the need for human intervention to remove the seal (an aerosol generating and contaminating process). Rinsing of the cutting heads 606 is performed by the robot 605 at its rinse station if desired between cutting operations on the entire plate. In this specific embodiment, all 96, 384, or other well plates can be prepared for aspiration by just one motion of the array cutting and folding tool 606. This tool 606 can be either hand operated, or designed with a robotic interface as another embodiment. Because this array cutting and tape folding tool 401 cuts and penetrates all wells on an individual plate simultaneously, it will require specific embodiments depending on the geometry of the plate to be accessed in addition to specific embodiments to operate on just one column of wells at a time verses the entire plate.

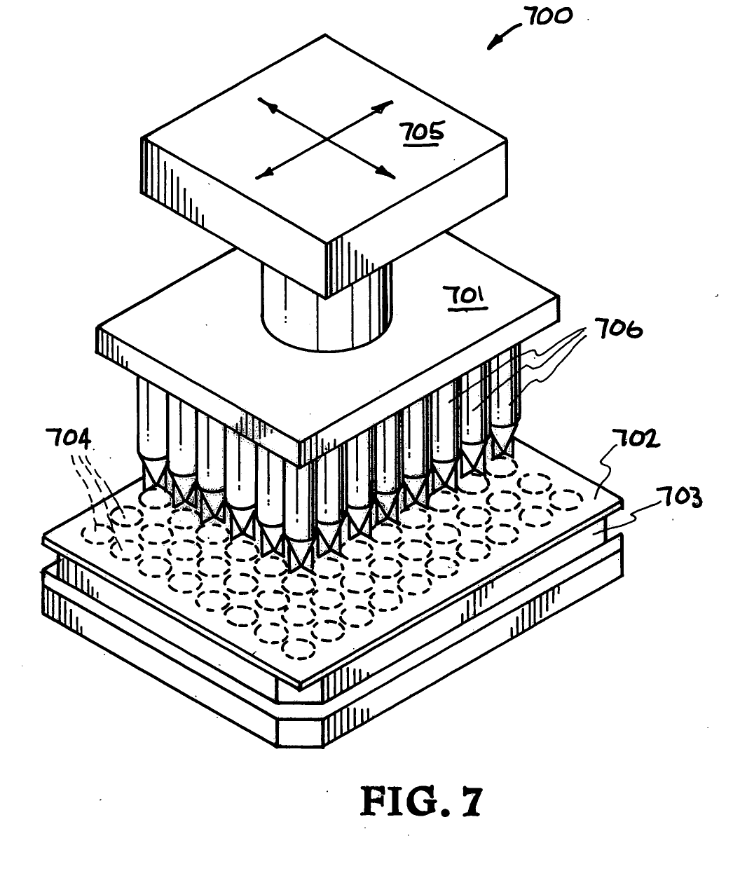

Referring now to FIG. 7, another embodiment of a multi-well sample plate cover penetration system constructed in accordance with the present invention is illustrated. This embodiment of the present invention is designated generally by the reference numeral 700. FIG. 7 illustrates a ninety six-well array 700 in a rectangular configuration. The ninety six-well array 700 is an 8 by 12 array of wells that hold the liquid samples during processing and moves between robotic platforms.

Laboratory analysis of chemical and biological samples is a time consuming process involving hundreds to thousands of samples for a typical test. These labor driven processes have led to the development of laboratory automation systems, now commonplace, that aspirate, mix, dispense, heat, and perform other operations according to the specific experimental protocols on large numbers of samples simultaneously.

To keep the liquid solutions inside the well, the plates are sealed typically with an adhesive backed aluminum foil tape as the most cost effective method. (Other sealing methods are much more expensive, time consuming, and only marginally more effective, involving multi-piece assemblies with coverlocks, diaphragms, or other mechanisms. Thus they are not widely used.)

The plates are then transferred, heated, centrifuged, bead beaten (vibrated on a shaker while beads previously deposited in the wells mix the sample and breakdown fibers, cell walls, spores, and other structures), and other operations depending on the specific experiment protocol. After these processes are performed the samples then need to be aspirated for chemical detection or subsequent tests, necessitating well penetration. Cross-contamination concerns require the wells are accessed with a minimum of aerosol generation. Standard aluminum sealing tape is used in mixing and beating processes.

Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

The ninety six-well array 700 includes an array of well cutting heads 701 positioned to penetrate a cover 702 of a multi-well sample plate 703 containing a multiplicity of individual sample wells 704. The sample plate 700 contains 96 individual wells in 12 columns of 8 rows.

The array of cutting heads 701 is driven by a robot 705. The array of cutting heads 701 includes a multiplicity of individual cutting heads 706. The individual cutting heads 706 are positioned in 12 columns of 8 rows along the array of well cutting heads 701 providing ninety six individual cutting heads 706. The rows and columns are spaced at the same intervals as the individual sample wells 704 in the multi-well sample plate 703. This assures that an individual cutting head 706 will be immediately above a corresponding sample well 704.

The wells 706 contain liquid samples for use in biological or chemical analyses. The wells 706 are covered with a seal such as an aluminum tape or foil 702. The wells 706 need to be penetrated for sampling and analysis.

The array of cutter heads 701 is moved and positioned by the robot 705. The array of cutter heads 701 is moved so that the individual cutting heads 706 are above the cover 702 in the precise position for penetrating the cover 702 above a corresponding multiplicity of individual wells 704. The robot 705 moves the array of cutting heads 701 and the individual cutting heads 706 downward toward the foil 702. The individual cutting heads 706 pierce the foil 702. Each individual split is made so that the foil 702 is split open and folded inward toward the individual well 704. The well 704 is then open for sample aspiration but has been protected from cross contamination.

Instead of peeling the tape 702 off the wells 704 to access the samples and potentially cross-contaminating adjacent wells with generated aerosols or adhesive strings, as was the case of the prior art, the foil 702 is pierced by the cutter 705 of the cutting head 701 that splits, opens, and folds the foil 702 inward toward the individual well 704. The wells 704 are then open for sample aspiration but have been protected from cross contamination.

The system 700 provides an array of cutting and tape folding tools 706 that can be used for 96-well, 384-well geometries, and other geometries. In other embodiments of the present invention that will be described subsequently, the system will be robotically operating and will cut, open, and fold inward the sealing tape so that samples can be subsequently aspirated without the need for human intervention to remove the seal (an aerosol generating and contaminating process).

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring again to FIG. 7, the system 700 provides an array cutting and tape folding tool 401 used for a 96-well geometry. The system 700 is robotically operated and will cut, open, and fold inward the sealing tape 702 on all the wells 704 on the plate 703 simultaneously so that samples can be subsequently aspirated without the need for human intervention to remove the seal (an aerosol generating and contaminating process). Rinsing of the cutting heads 706 is performed by the robot 705 at its rinse station if desired between cutting operations on the entire plate. All 96 well plates 704 can be prepared for aspiration by just one motion of the array cutting and folding tool 706. This array cutting and tape folding system 700 cuts and penetrates all wells on an individual plate simultaneously.

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Other embodiments of the present invention provide rectangular well arrays with geometries other than the ninety six-well array 700. For example, rectangular configurations of 384, 1536 and other rectangular geometries.

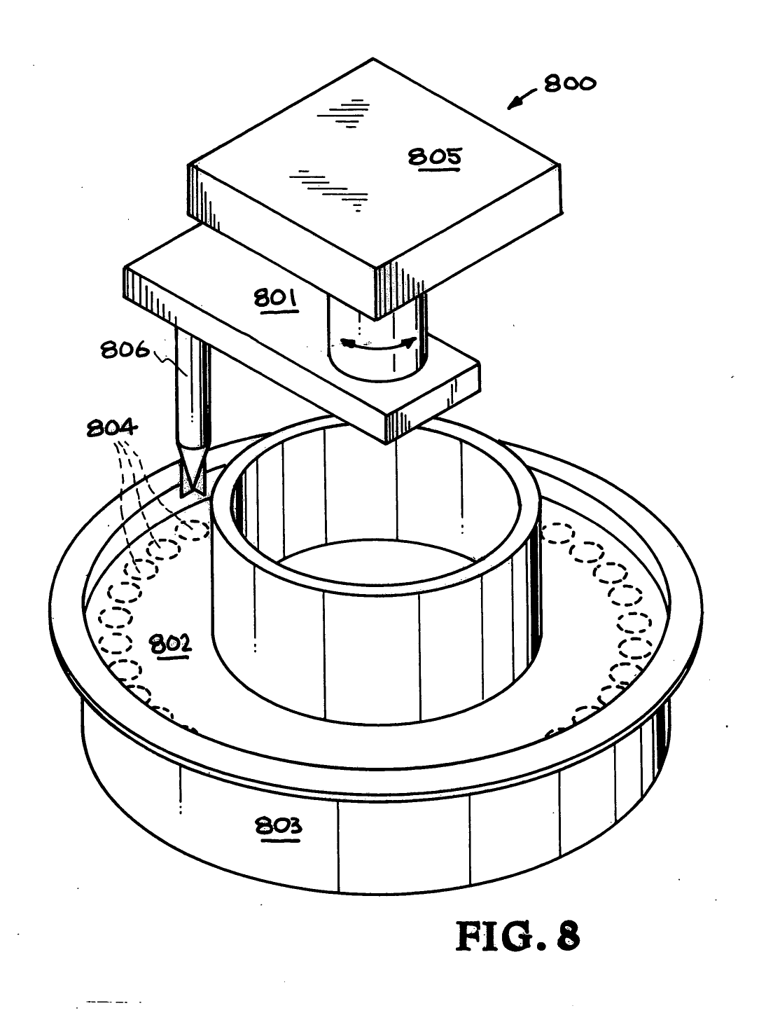

Referring now to FIG. 8, another embodiment of a multi-well sample plate cover penetration system constructed in accordance with the present invention is illustrated. This embodiment of the present invention is designated generally by the reference numeral 800. FIG. 8 illustrates a circular array. The circular array 800 can be arranged to contain various numbers of wells that hold the liquid samples during processing and moves between robotic platforms. For example, the circular array 800 can be constructed in 16, 32, and 100 well geometries.

The circular array 800 illustrated in FIG. 8 includes an array of well cutting heads 801 positioned to penetrate a cover 802 of a multi-well sample plate 803 containing a multiplicity of individual sample wells 804. The array of cutting heads 801 is driven by a robot 805. The array of cutting heads 801 includes a multiplicity of individual cutting heads 806. The individual cutting heads 806 are positioned in annular rows in the cutting heads 801. Depending on the arrangement the cutting heads 801 can provide 16, 32, and 100, etc. individual cutting heads 806. The cutting heads 801 are spaced at the same intervals as the individual sample wells 804 in the multi-well sample plate 803. This assures that an individual cutting head 806 will be immediately above a corresponding sample well 804.

The wells 806 contain liquid samples for use in biological or chemical analyses. The wells 806 are covered with a seal such as an aluminum tape or foil 802. The wells 806 need to be penetrated for sampling and analysis.

The array of cutter heads 801 is moved and positioned by the robot 805. The array of cutter heads 801 is moved so that the individual cutting heads 806 are above the cover 802 in the precise position for penetrating the cover 802 above a corresponding multiplicity of individual wells 804. The robot 805 moves the array of cutting heads 801 and the individual cutting heads 806 downward toward the foil 802. The individual cutting heads 806 pierce the foil 802. Each individual split is made so that the foil 802 is split open and folded inward toward the individual well 804. The well 804 is then open for sample aspiration but has been protected from cross contamination.

Instead of peeling the tape 802 off the wells 804 to access the samples and potentially cross-contaminating adjacent wells with generated aerosols or adhesive strings, as was the case of the prior art, the foil 802 is pierced by the cutter 805 of the cutting head 801 that splits, opens, and folds the foil 802 inward toward the individual well 804. The wells 804 are then open for sample aspiration but have been protected from cross contamination.

The system 800 provides an array of cutting and tape folding tools 806 that can be used for 16, 32, and 100-well geometries, and other geometries. In other embodiments of the present invention that will be described subsequently, the system will be robotically operating and will cut, open, and fold inward the sealing tape so that samples can be subsequently aspirated without the need for human intervention to remove the seal (an aerosol generating and contaminating process).

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

Referring again to FIG. 8, the system 800 provides an array cutting and tape folding tool 401 used for a 16, 32, and 100-well geometries. The system 800 is robotically operated and will cut, open, and fold inward the sealing tape 802 on all the wells 804 on the plate 803 simultaneously so that samples can be subsequently aspirated without the need for human intervention to remove the seal (an aerosol generating and contaminating process). Rinsing of the cutting heads 806 is performed by the robot 805 at its rinse station if desired between cutting operations on the entire plate.

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

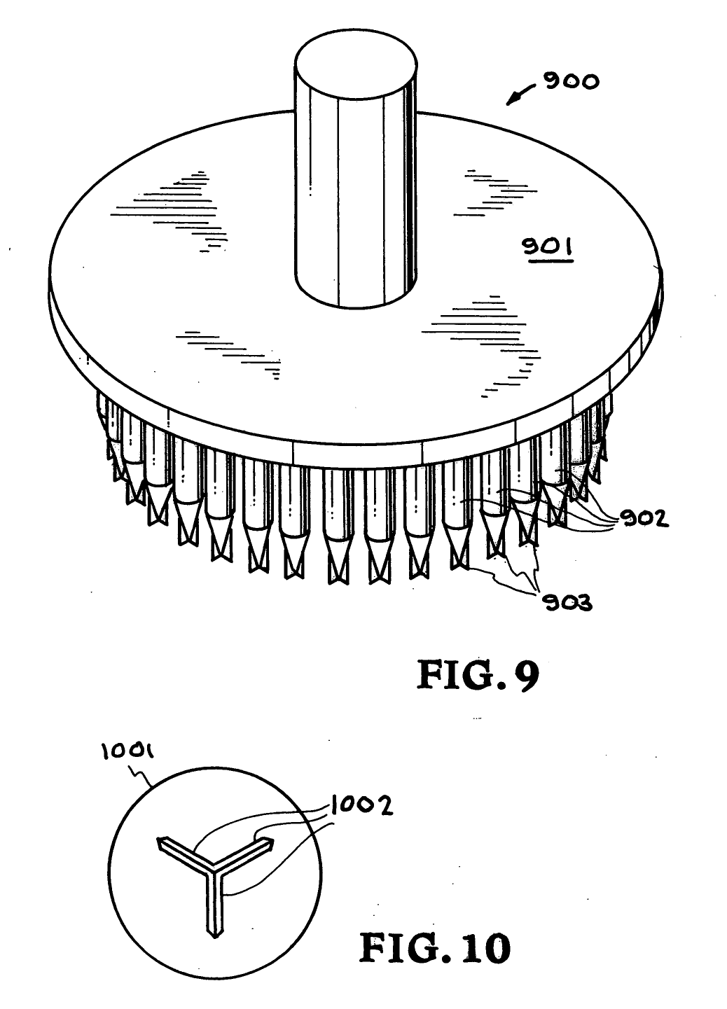

Referring now to FIG. 9, a circular array is illustrated in greater detail. The circular array 900 is designated generally by the reference numeral 900. The circular array 900 can be arranged to contain various numbers of wells that hold liquid samples during processing and movement by robotic platforms. The circular array 900 can be constructed in 16, 32, 100, and other well geometries.

The circular array 900 includes an array 901 of well cutting heads 902. The well cutting heads 902 can be positioned to penetrate the cover of a matching circular multi-well sample plate containing individual sample wells. The array 901 of cutting heads 902 can be driven by a robot. The cutting heads 902 include individual cutting heads 903.

Referring now to FIG. 10, a bottom view of a cutting head 1001 is shown. The cutting head 1001 is moved by the robot shown in the various other figures to cause the cutting tool to contact and penetrate the cover over the wells of the multi-well sample plate. The cutting tool portion of the cutting head 1001 is in the form of a “Y.” The cutting head includes three cutting blades 1002. The cutting blades 1002 are located on the conical tip of the cutting head 1001 and cause the foil to be folded inward toward the well.

In operation, the cutting head 1001 is moved by the robot to cause the cutting tool to contact and penetrate the cover over the wells of the multi-well sample plate. The cutting blades 1002 form a “Y” cut in the cover. The conical tip moves into the “Y” and cause the foil of the cover to be folded inward toward the well. The cutter tool pierces the foil so that the well is open for sample aspiration. The cutting blades 1002 and the conical tip cause the foil to be folded inward toward the well. The well is open for sample aspiration but has been protected from cross contamination.

The present invention not only eliminates cross contamination, it also automates other steps in the experimental protocol. Current standard accepted laboratory protocols are so concerned with the proven cross contamination vector of the tape removal process (the tape is currently peeled back from the entire plate by hand generating adhesive strings that cross wells and jostling the then open wells) that much slower and more time consuming processes are performed instead of tape sealing such as removal of the samples from the plate and processing with individual capillary tubes, a tremendous disadvantage in both time and expense.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A multi-well cover penetration apparatus for penetrating a cover over a multi-well sample plate containing a multiplicity of individual sample wells, comprising:
a rectangular or circular cutting head,
a multiplicity of cutters extending from said cutting head, and
a robot, said cutting head connected to said robot wherein said robot moves said cutting head and cutters so that said cutters penetrate the cover over the multi-well sample plate providing access to the individual sample wells.

2. The multi-well cover penetration apparatus of claim 1 wherein said cutting head is a rectangular cutting head and said multiplicity of cutters are arranged in columns and rows.

3. The multi-well cover penetration apparatus of claim 1 wherein said cutting head is a rectangular cutting head and said multiplicity of cutters are arranged in twelve columns of eight rows to form a ninety six cutter cutting head.

4. The multi-well cover penetration apparatus of claim 1 wherein said cutting head is a rectangular cutting head and said multiplicity of cutters are arranged in columns and rows to form a three hundred eight four cutter cutting head.

5. The multi-well cover penetration apparatus of claim 1 wherein said cutting head is a rectangular cutting head and said multiplicity of cutters are arranged in columns and rows to form a one thousand five hundred thirty six cutter cutting head.

6. The multi-well cover penetration apparatus of claim 1 wherein said cutting head is a circular cutting head.

7. The multi-well cover penetration apparatus of claim 1 wherein said cutting head is a circular cutting head and said multiplicity of cutters are arranged to form a sixteen cutter cutting head.

8. The multi-well cover penetration apparatus of claim 1 wherein said cutting head is a circular cutting head and said multiplicity of cutters are arranged to form a thirty two cutter cutting head.

9. The multi-well cover penetration apparatus of claim 1 wherein said cutting head is a circular cutting head and said multiplicity of cutters are arranged to form a one hundred cutter cutting head.

10. The multi-well cover penetration apparatus of claim 1 wherein each of said cutters have crossed cutting blades.

11. The multi-well cover penetration apparatus of claim 1 wherein said cutter has crossed cutting blades in the form of an “X.”

12. The multi-well cover penetration apparatus of claim 1 wherein said cutter has cutting blades in the form of a “Y.”

13. A multi-well cover penetration apparatus for penetrating a cover over a multi-well sample plate containing a multiplicity of individual sample wells, comprising:
a rectangular or circular cutting head,
a multiplicity of cutters extending from said cutting head, and
means for moving said cutting head so that said cutters penetrate the cover over the multi-well sample plate providing access to the individual sample wells.

14. The multi-well cover penetration apparatus of claim 13 wherein said cutting head is a rectangular cutting head and said multiplicity of cutters are arranged in columns and rows.

15. The multi-well cover penetration apparatus of claim 13 wherein said cutting head is a rectangular cutting head and said multiplicity of cutters are arranged in twelve columns of eight rows to form a ninety six cutter cutting head.

16. The multi-well cover penetration apparatus of claim 13 wherein said cutting head is a rectangular cutting head and said multiplicity of cutters are arranged in columns and rows to form a three hundred eight four cutter cutting head.

17. The multi-well cover penetration apparatus of claim 13 wherein said cutting head is a rectangular cutting head and said multiplicity of cutters are arranged in columns and rows to form a one thousand five hundred thirty six cutter cutting head.

18. The multi-well cover penetration apparatus of claim 13 wherein said cutting head is a circular cutting head.

19. The multi-well cover penetration apparatus of claim 13 wherein said cutting head is a circular cutting head and said multiplicity of cutters are arranged to form a sixteen cutter cutting head.

20. The multi-well cover penetration apparatus of claim 13 wherein said cutting head is a circular cutting head and said multiplicity of cutters are arranged to form a thirty two cutter cutting head.

21. The multi-well cover penetration apparatus of claim 13 wherein said cutting head is a circular cutting head and said multiplicity of cutters are arranged to form a one hundred cutter cutting head.

22. The multi-well cover penetration apparatus of claim 13 wherein each of said cutters have crossed cutting blades.

23. The multi-well cover penetration apparatus of claim 13 wherein said cutter has crossed cutting blades in the form of an “X.”

24. The multi-well cover penetration apparatus of claim 13 wherein said cutter has cutting blades in the form of a “Y.”
